(19) United States
(12) Patent Application Publication
(10) Pub. No.: US 2020/0146436 A1
(43) Pub. Date: May 14, 2020

(54) MULTI-FUNCTIONAL PAINT TOOL

(71) Applicant: 1310 Ventures LLC, College Station, TX (US)

(72) Inventors: Landon Harrell, College Station, TX (US); John Warren, College Station, TX (US); Cosmin Orha, Milan (IT)

(21) Appl. No.: 16/190,065

(22) Filed: Nov. 13, 2018

(51) Int. Cl. A46B 15/00; B25F 1/00; B25G 3/12; A46B 5/00; A46B 7/04; B67B 7/12

(52) U.S. Cl. CPC A46B 15/0063; B25F 1/006; B25G 3/12; A46B 2200/202; A46B 7/044; A46B 7/042; B67B 7/12; A46B 5/0095

(57) ABSTRACT

A multi-functional paint tool including a base including a handle on first end and a channel structure on a second end; and a head including a cavity on a bottom end and a plurality of bristles on a top end; wherein the cavity of the head is slidably received onto the channel structure of the base for engagement thereon. The base can include a U-shaped opening and a hammer. The head includes a paint applicator on the top end, and in other embodiments the paint applicator may take on alternative forms.

### BACKGROUND

### Technical Field

The present application relates to a multi-functional paint tool to decrease the number of paint brushes and tools needed for a painting job.

### Description of Related Art

When a painting task arises, a painter needs a plurality of tools to complete the job. Generally, these tools include something to pry the paint can open, multiple brushes varying in size, and something to close the paint can. One problem a painter might face is keeping track of all those different tools. Additionally, buying multiple tools for a single painting task can be costly. For the foregoing reasons, there is a need for a tool that can serve the many functions that painting requires.

Conventional paintbrushes are limited in that they are configured to only be used a limited number of times before disposal of the entire paintbrush. Conventional paintbrushes are also limited in that they are typically only configured to paint. Conventional paintbrushes lack the capability to reuse certain parts of the paintbrush and to use the paintbrush for the multiple functions that a paint job requires.

Traditional paint jobs require the use of multiple tools to fully complete the job. In a traditional paint job, a painter would need a tool to open a can of paint. The painter may need a variety of types of paintbrushes as well as lengths of paintbrush handles. The painter may also need to rest the paintbrush down between tasks. After completion of the paint job, the painter may need to hammer the paint lid back on to the paint can for storage. Conventional paintbrushes lack the capability to address all these needs that painters have.

### BRIEF SUMMARY

In a first aspect, there is provided a multi-functional paint tool including a base including a handle on first end and a channel structure on a second end; a head including a cavity on a bottom end and a plurality of bristles on a top end; wherein the cavity of the head is slidably received onto the channel structure of the base for engagement thereon.

In an embodiment, the head includes a channel groove on the bottom end of the head and the channel groove of the head is slidably received onto the channel structure of the base for engagement thereon.

In another embodiment, the channel groove on the head includes a head axis that runs across the bottom of the head and the channel groove is slideably received onto the channel structure on the base for attachment thereon.

In an exemplary embodiment, the channel structure on the base includes a base axis that runs across the first end of the base and the channel structure is slideably accepted into the channel groove on the head for attachment thereon.

In an illustrative embodiment, the tool further comprises a locking mechanism which is configured to lockingly engage the head to the base.

In an embodiment, the locking mechanism further comprises a protrusion and the channel structure on the second end of the base; a recess in the channel groove on the bottom end of the head; wherein the channel structure on the base slidably accepts the channel groove on the head which moves along a head axis that runs across the bottom of the head; and wherein the protrusion on the base is received into the recess of the head which locks the base and the head.

In an exemplary embodiment, the tool further comprises a release mechanism which is configured to detach the base from the head.

In an illustrative embodiment, the release mechanism further comprises: a tab on the second end of the base; wherein exerting downward force onto the tab disengages the protrusion on the base from the recess on the head, thereby causing the channel structure on the base to unlock the base from the head.

In another embodiment, the base further comprises a hammer on the second end of the base.

In an embodiment, the base further comprises an U-shaped opening on the second end of the base.

In yet still another embodiment, the base further comprises a hole on the first end of the base under the handle.

In an embodiment, the U-shaped opening includes an arm which extends past the second end of the base and the arm is exerted downward force to pry open a sealed container.

In another embodiment, the U-shaped opening includes an opening to rest the tool on an edge of a container.

In an exemplary embodiment, the hole includes a track of threads on the inside of the hole.

In a second aspect, there is provided a multi-functional paint tool including a base including a protrusion and a channel structure on a second end; and a head including a recess in a channel groove on a bottom end of a head; wherein the protrusion on the base is received into the recess of the head which lockingly engages the base and the head.

In an embodiment, the channel structure of the base includes a base axis that runs across the second end of the base and the channel structure on the base slideably accepts the channel groove on the head for attachment thereon.

In another embodiment, the channel groove of the head includes a head axis that runs across the bottom of the head and the channel groove is slideably received onto the channel structure of the base for attachment thereon.

In an embodiment, the tool further includes a tab and a protrusion on a second end of a base; and a recess on a bottom of a head; wherein exerting downward force onto the tab disengages the protrusion on the base from the recess on the head.

In an exemplary embodiment, the channel structure is disposed on the second end of the base and the channel groove is disposed on the bottom of the head; wherein exerting downward force onto the tab disengages the protrusion on the base from the recess on the head, thereby causing the channel structure on the base to unlock the base from the head.

Other aspects, features, and advantages will become apparent from the following detailed description when taken in conjunction with the accompanying drawings, which are a part of this disclosure and which illustrate, by way of example, principles of the inventions disclosed.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of an assembled multi-function paint tool, according to an exemplary embodiment;

FIG. 2 is a schematic front view of a base of the multi-functional paint tool in FIG. 1;

FIG. 3 is a top view of the base of the multifunctional paint tool in FIG. 1 with the handle portion omitted;

FIG. 4 is a left view of the base of the multifunctional paint tool in FIG. 1 with the handle portion omitted;

FIG. 5 is a front view of the head of the multi-functional paint tool in FIG. 1;

FIG. 6 is a bottom view of the head of the multifunctional paint tool in FIG. 1;

FIG. 7 is a left view of the head of the multifunctional paint tool in FIG. 1;

FIG. 8 shows the head sliding onto the base along the base axis of the of the multifunctional paint tool in FIG. 1; and

FIG. 9 shows disengagement by a user's thumb of the head sliding off the base along the base axis of the of the multifunctional paint tool in FIG. 1.

### DESCRIPTION OF THE PREFERRED EMBODIMENT

Illustrative embodiments of the tool and methods of the present application are described below. In the interest of clarity, all features of an actual implementation may not be described in this specification. It will, of course, be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The particular embodiments disclosed above are illustrative only, as the apparatus may be modified and practiced in different but equivalent manners apparent to those skilled in the art having the benefit of the teachings herein. Modifications, additions, or omissions may be made to the apparatuses described herein without departing from the scope of the embodiment. The components of the tool may be integrated or separated. Moreover, the operations of the tool and methods described herein may be performed by more, fewer, or other components.

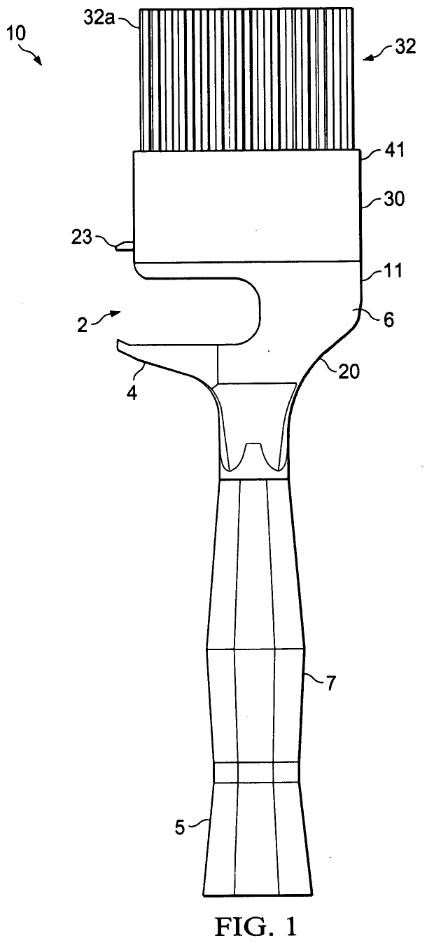

Referring to FIG. 1, a multi-functional paint tool 10 which is comprised of a base 20 and a head 30. The base 20 includes a handle 7 on first end 5, a U-shaped opening 2 on a second end 6, a tab 23 on the second end 6, and a hammer 11 on the second end 6 opposite from the U-shaped opening 2. The head 30 includes a paint applicator 32 on a top end 41. In an exemplary embodiment, the paint applicator 32 is a plurality of bristles 32a. In other embodiments, the head 30 can be alternative forms, such as a roller brush.

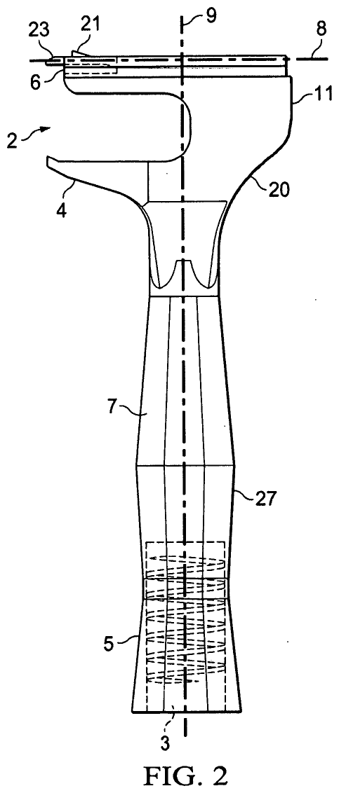

Referring to FIGS. 2-4, the base 20 is detached from the head 30. The base 20 includes a channel structure 25 on the second end 6 which runs across a base axis 8 of the second end 6 of the base 20. The base axis 8 is substantially perpendicular to the longitudinal tool axis 9 that extends through the top of the bottom of the assembled tool 10. In other words, base axis 8 is a transverse axis (e.g., perpendicular to longitudinal tool axis 9). The base axis 8 is perpendicular to the longitudinal tool axis 9 which extends from the left to the right of the tool 10 (i.e. does not extend front to back). The base 20 includes a protrusion 21 that is adjacent to the U-shaped opening 2. The protrusion 21 is a component for locking the head 30 in with the base 20, and a release tab 23 which is an element for unlocking the head 30 from the base 20. The protrusion 21 is wedged shaped which can make for a friction fit into the head 30. The hole 3 on the first end 5 of the base 20 has threads that can allow an extension arm of the handle 7 to be inserted and secured therein for the purpose of painting high or far to reach places.

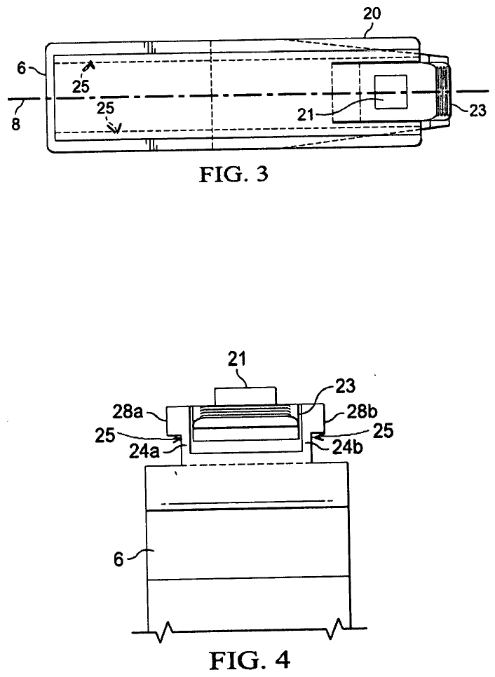

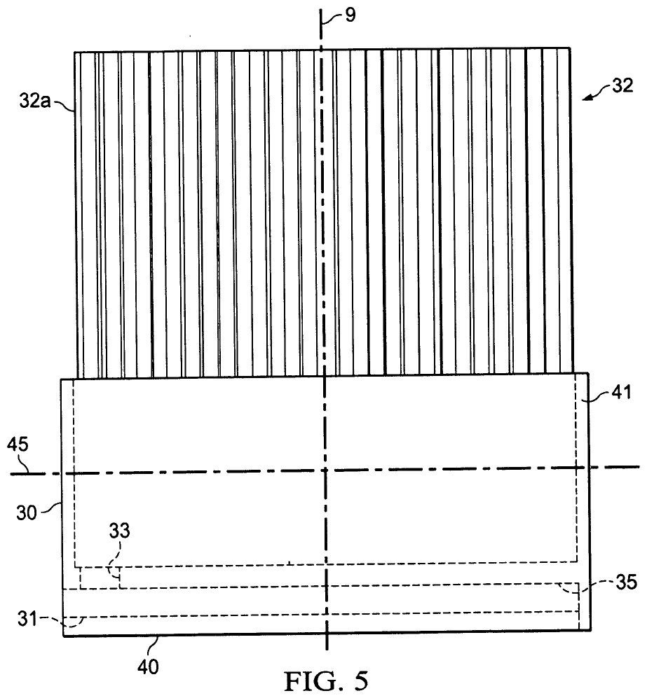

Referring to FIGS. 3-4, the base 20 is detached from the head 30. The base 20 on its second end 6 includes a channel structure 25 having walls 24a, 24b (e.g., vertical, recessed walls) and flanges 28a, 28b that can be outwardly extending projections. The walls 24a, 24b and flanges 28a, 28b can be continuous along the front and back sides of the base axis 8. The walls 24a, 24b and flanges 28a, 28b can be integrally formed with the base 20. The walls 24a, 24b and flanges 28a, 28b can slidably secure the base 20 to the head 30 thereon.

Referring to FIGS. 5-7, the head 30 detached from the base 20 shows a cavity 31 on the bottom end 40 and bristles 32a on top end 41. In other embodiments, the head 30 can be alternative forms, such as a roller brush. A channel groove 35 runs across the head axis 45 of the bottom of the head 30. The head axis 45 is substantially perpendicular to the longitudinal tool axis 9 and extends from the left to the right of the tool 10 (i.e., does not extend front to back). The cavity 31 includes a recess 33 disposed therein for releasably locking the head 30 into the base 20. The channel groove 35 is for the purpose of being slideably received onto the channel structure 25 on the base 20 for attachment thereon.

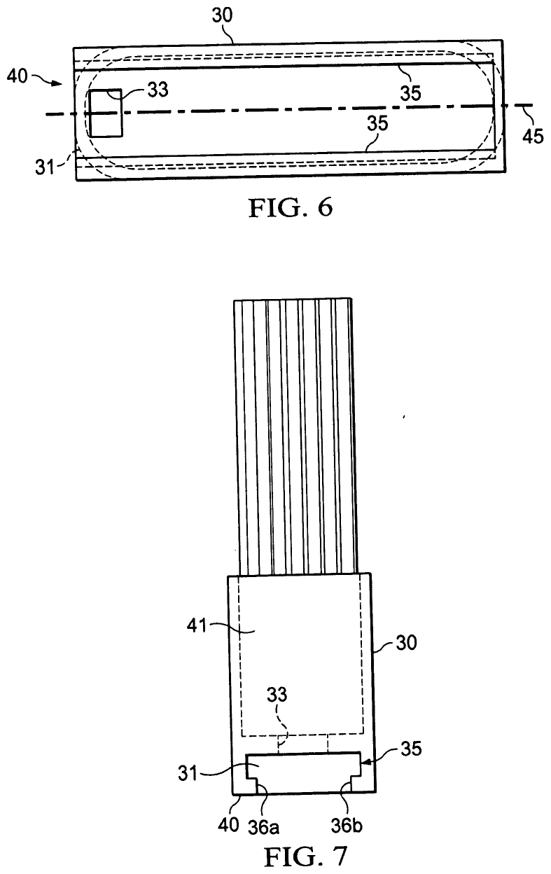

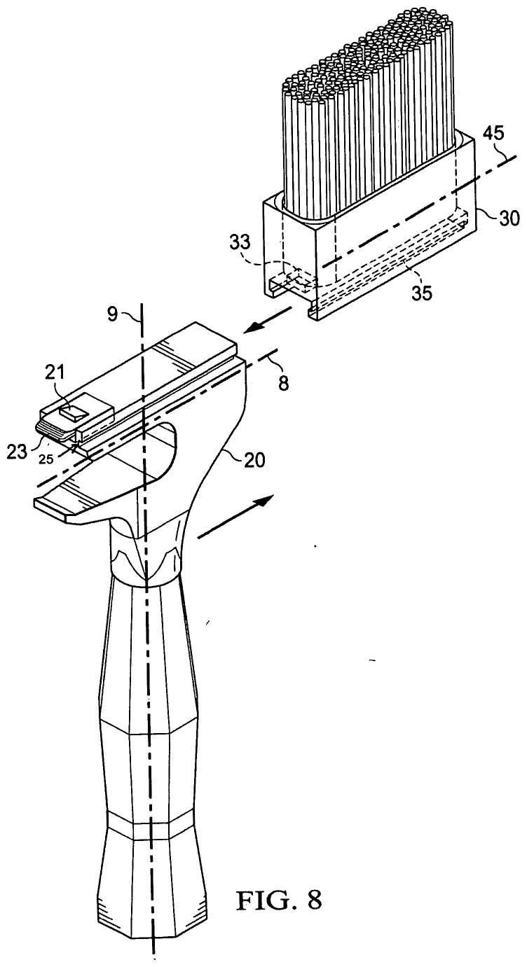

Referring to FIGS. 6-7, the head 30 detached from the base 20 includes a channel groove 35 on the bottom end 40 of the head 30. The channel groove 35 includes ridges 36a, 36b on the sides that are configured to slidably engage the flanges 28a, 28b and walls 24a, 24b on the base 20. The ridges 36a, 36b can be continuous and inwardly extending down the head axis 45, and integrally formed with the head 30. The ridges 36a, 36b can provide sufficient rigidity so that the head 30 is secured on the base 20.

Referring to FIG. 8, the locking mechanism is configured to lockingly engage the head 30 to the base 20. The base 20 and channel structure 25 of the base 20 is slideably accepted into the channel groove 35 of the head 30, which thereby allows the head 30 to slide along the base axis 8 (e.g., in a horizontal direction) of the base 20 to engage the protrusion 21 and the recess 33. This in turn engages the protrusion 21 on the base 20 is received into the recess 33 on the head 30, thereby locking the head 30 onto the base 20. Once the recess 33 engages with the protrusion 21, the channel structure 25 is sufficiently prevented from moving in the channel groove 35 while the multi-functional tool 10 is in use.

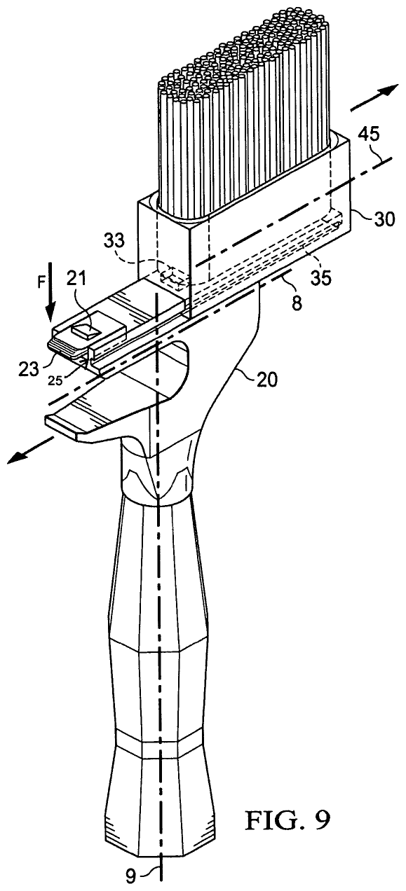

Referring to FIG. 9, a release mechanism is configured to detach the base 20 from the head 30. The base 20 is slideably detached from the head 30 by engaging the tab 23 on the second end 6 of the base 20. To unlock the base 20 from the head 30 the user must exert downward force on the tab 23. This will disengage the protrusion 21 from the recess 33 thereby allowing the channel structure 25 of the base 20 to slide out of the channel groove 35 of the head 30. The release tab 23 is an improvement from other detachable brushes because it is user friendly and makes the clean-up process easier because it prevents less paint build up within the tool 10.

Referring to FIGS. 1-2, the U-shaped opening 2 includes an arm 4 that extends beyond the periphery of the second end 6 of the base 20. Applying a downward force via handle 7 to the extended arm 4 can be used to pry open sealed containers. The user can place the paint applicator 32 with the U-shaped opening 2 on the edge of containers which allows the paint applicator 32 to drip paint back into the can. One benefit to this function gives the users a free hand and creates less of a mess and clean up for the painting task.

The multi-functional paint tool described herein provides significant advantages over conventional paintbrushes and painter tools. For example, the ability to attach and remove different paintbrush heads allows a painter to use a single tool for the different paintbrush heads that a painting job might require. Additionally, this ability allows the painter to dispose of the paintbrush head itself, rather than the entire multipurpose paint tool. Even further, the shape of the track, along with shape of the channel and the engagement of the male connecting structure and the female connecting structure allows a heightened stability for the paintbrush head while the multipurpose paint tool is in use. The inclusion of the hammer 11, the wedge, the threaded opening, and the u-shaped slot allows a painter to use one tool rather than have a plurality of tools which might prove burdensome.

1. A multi-functional paint tool comprising:
a base including a handle on first end and a channel structure on a second end; and
a head including a cavity on a bottom end and a plurality of bristles on a top end;
wherein the cavity of the head is slidably received onto the channel structure of the base for engagement thereon.

2. The tool of claim 1, wherein the head includes a channel groove on the bottom end of the head and the channel groove of the head is slidably received onto the channel structure of the base for engagement thereon.

3. The tool of claim 2, wherein the channel groove on the head includes a head axis that runs across the bottom of the head and the channel groove is slideably received onto the channel structure on the base for attachment thereon.

4. The tool of claim 2, wherein the channel structure on the base includes a base axis that runs across the first end of the base and the channel structure is slideably accepted into the channel groove on the head for attachment thereon.

5. The tool of claim 2, further comprising:
a locking mechanism which is configured to lockingly engage the head to the base.

6. The tool of claim 5, wherein the locking mechanism further comprises:
a protrusion and the channel structure on the second end of the base; and
a recess in the channel groove on the bottom end of the head;
wherein the channel structure on the base slidably accepts the channel groove on the head which moves along a head axis that runs across the bottom of the head;
wherein the protrusion on the base is received into the recess of the head which locks the base and the head.

7. The tool of claim 6, further comprising:
a release mechanism which is configured to detach the base from the head.

8. The tool of claim 7, wherein the release mechanism further comprises:
a tab on the second end of the base;
wherein exerting downward force onto the tab disengages the protrusion on the base from the recess on the head, thereby causing the channel structure on the base to unlock the base from the head.

10. The tool of claim 1, wherein the base further comprises a hammer on the second end of the base.

11. The tool of claim 1, wherein the base further comprises an U-shaped opening on the second end of the base.

12. The tool of claim 1, wherein the base further comprises a hole on the first end of the base under the handle.

13. The tool of claim 11, wherein the U-shaped opening includes an arm which extends past the second end of the base and the arm is exerted downward force to pry open a sealed container.

14. The tool of claim 11, wherein the U-shaped opening includes an opening to rest the tool on an edge of a container.

15. The tool of claim 12, wherein the hole includes a track of threads on the inside of the hole.

16. A multi-functional paint tool comprising:
a base including a protrusion and a channel structure on a second end; and
a head including a recess in a channel groove on a bottom end of a head;
wherein the protrusion on the base is received into the recess of the head which lockingly engages the base and the head.

17. The tool of claim 16, wherein the channel structure of the base includes a base axis that runs across the second end of the base and the channel structure on the base slideably accepts the channel groove on the head for attachment thereon.

18. The tool of claim 16, wherein the channel groove of the head includes a head axis that runs across the bottom of the head and the channel groove is slideably received onto the channel structure of the base for attachment thereon.

19. The tool of claim 16, further comprising:
a tab and a protrusion on a second end of a base; and
a recess on a bottom of a head;
wherein exerting downward force onto the tab disengages the protrusion on the base from the recess on the head.

20. The tool of claim 19, wherein the channel structure is disposed on the second end of the base and the channel groove is disposed on the bottom of the head;
wherein exerting downward force onto the tab disengages the protrusion on the base from the recess on the head, thereby causing the channel structure on the base to unlock the base from the head.
